(19) United States
(12) Patent Application Publication
(10) Pub. No.: US 2009/0327439 A1
(43) Pub. Date: Dec. 31, 2009

(54) MOBILE PHONE AND COMPUTER MESSAGE SYSTEM

(76) Inventor: Tracy M. Heims, Seattle, WA (US)

Correspondence Address: APEX JURIS, PLLC, 12733 LAKE CITY WAY NORTHEAST, SEATTLE, WA, 98125, US

(21) Appl. No.: 12/492,106

(22) Filed: Jun. 25, 2009

Related U.S. Application Data
(60) Provisional application No. 61/075,652, filed on Jun. 25, 2008.

(51) Int. Cl. G06F 15/82

(52) U.S. Cl. 709/206

(57) ABSTRACT

A computer and mobile phone user interface system that includes a computer, a mobile phone, and a messaging system where the messaging system displays messages on both the computer and on the mobile phone that notify the user as to from where the messages were opened or sent and that further deletes messages from the mobile phone when they are deleted from the computer.

### PRIORITY

This application claims priority to previously filed Provisional Application, Ser. No. 61/075,652 filed Jun. 25, 2008.

### BACKGROUND OF THE INVENTION

1. Field of the Invention

The present invention relates to mobile phones and particularly to smart phones that utilize email programs and more specifically to smart phones that sync with Microsoft Outlook or other email programs that use an exchange server to sync email between an office, home, home office or any other computer and the mobile device.

2. Description of the Background Art

Currently, if a person is uses a mobile phone or device, (hereinafter “mobile”) it is extremely desirable to receive email or messages via their mobile. Many people use a centrally located mail server that syncs their email, messages, tasks, calendars and other utilities between the computer and the mobile device. They use what is presently called a “push” mail service so that the mobile device is continually and timely updated whenever email is sent or received so that the mobile device is always up to date with the latest email. When someone utilizes this push mail system both the computer system and the mobile device receives and sends email simultaneously. Thus, when someone sends an email to the user the user receives the email on their phone and on their computer. When the user is working on his computer he can respond to the email. Alternatively, if the user is using the mobile phone then he can respond to the email via the mobile device or smart phone.

If the user responds to the message from his computer there appears a return arrow that lets the user know that he has responded to the message. This is extremely useful and informative as it notifies the user immediately as to if they have already responded to a message, thus saving time researching as to whether or not user has responded. Also, the “sent” message is stored in the “sent” folder and can be accessed at a later time from the sent folder.

Finally, if a user deletes a message from the computer it is removed from the mail list. This is of course helpful because it prevents a large pile up of unwanted messages.

There are several problems with the present push system and most of them deal with the way email or messages are handled. First, with respect to messages sent and received from the computer, when the user sends a message from the computer it does not show up on the mobile. It does not let the user know where it has been sent from or if it is a sent or received message.

Next, when the user replies to a message from the computer it also does not show up on the mobile as a reply, but only shows up as a new mail message. This can be extremely confusing and troublesome for the mobile user when the user is not sitting at the computer.

Next, with respect to messages sent and received from the mobile there are a variety of issues and problems. First, when a message is replied to or sent from the mobile device the mobile shows the same icon so that the user does not know if the mail sent is a reply to an email message or if it is a new message sent to a new recipient.

Also, when new messages are sent or a message is replied to from the mobile the computer does not show a new message or reply message. Basically, there is no notification on the computer indicating that anything had been sent from the mobile.

Next, mail messages tend to stack up on the mobile device because mail messages deleted from the computer do not get deleted from the mobile. This is also confusing because the user doesn't always know what should or has been deleted.

Finally, there is no “sent” folder on the mobile device. All mail messages go into the “in” box making it extremely confusing and difficult to manage messages.

### SUMMARY OF THE INVENTION

The present invention provides solutions to the above referenced problems that currently exist on mobile devices and computers, specifically with respect to the use of push email service. First, the present invention provides a means to notify the user of the mobile phone from where each and every message is sent. Thus, the present invention provides a means to notify the user on the mobile when he has sent a message from the computer or when he has sent a message from the mobile. This system provides a means to notify the mobile user with different icons the status of mail as sent, received, replied to or any other variety thereof.

Next, the system provides message uniformity. When mail is deleted from the computer it is then also deleted from the mobile device. This prevents mail pile up and eliminates unwanted mail items.

Finally, the system provides the option of storing sent items in a “sent” box similar to that on the computer in order to minimize the number of messages in the “in” box. This provides conformity and makes the systems more similar so that a user does not need to learn new message management.

### BRIEF DESCRIPTION OF THE DRAWINGS

FIG. 1a is an illustration of an opened envelope with a notification showing that a reply was sent from the computer.

FIG. 1b is a different embodiment showing that a reply was sent from the computer.

FIG. 1c shows that a reply was sent from the mobile or Blackberry.

FIG. 2a is an illustration of an opened envelope showing a notification that a message was sent from the mobile device.

FIG. 2b is another illustration showing a different type of notification.

FIG. 2c is another illustration showing that a mail message was sent from the computer.

FIG. 3 and FIG. 3b are illustrations of opened envelopes on either the computer or the mobile showing where the mail was opened.

FIG. 3a shows that the mail was opened from the mobile device (obb—opened at Blackberry) and

FIG. 3b shows that the mail was opened at the computer (oc—opened at computer).

### DESCRIPTION OF THE PREFERRED EMBODIMENTS

A detailed description will now be given of illustrative embodiments of the present invention, with reference to the accompanying drawings. In so doing, specific terminology is employed solely for the sake of clarity, and the present disclosure is not to be limited to the specific terminology so selected. It is to be understood that each specific element includes all technical equivalents that operate in a similar manner and achieve a similar result.

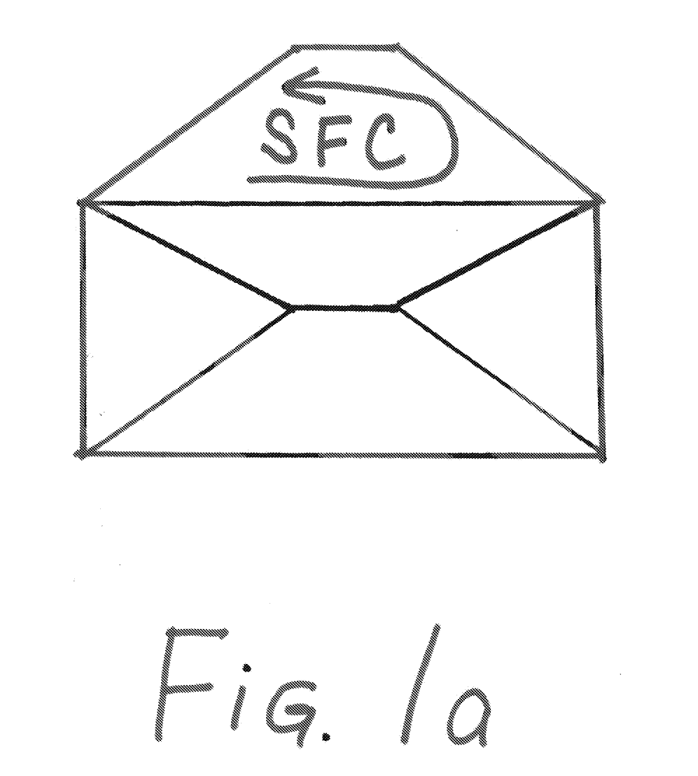

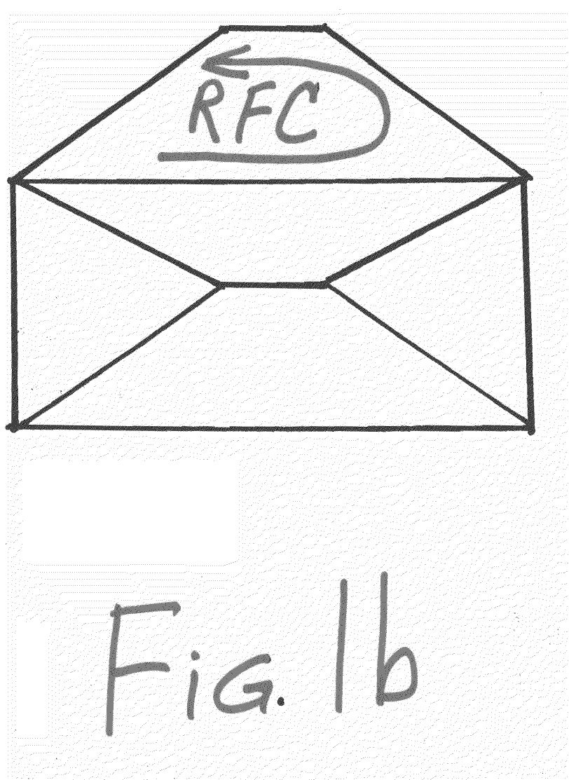

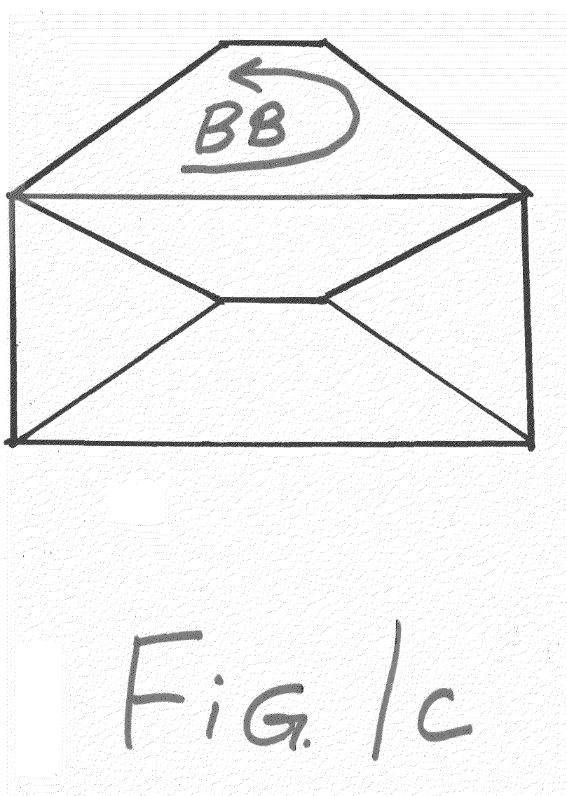

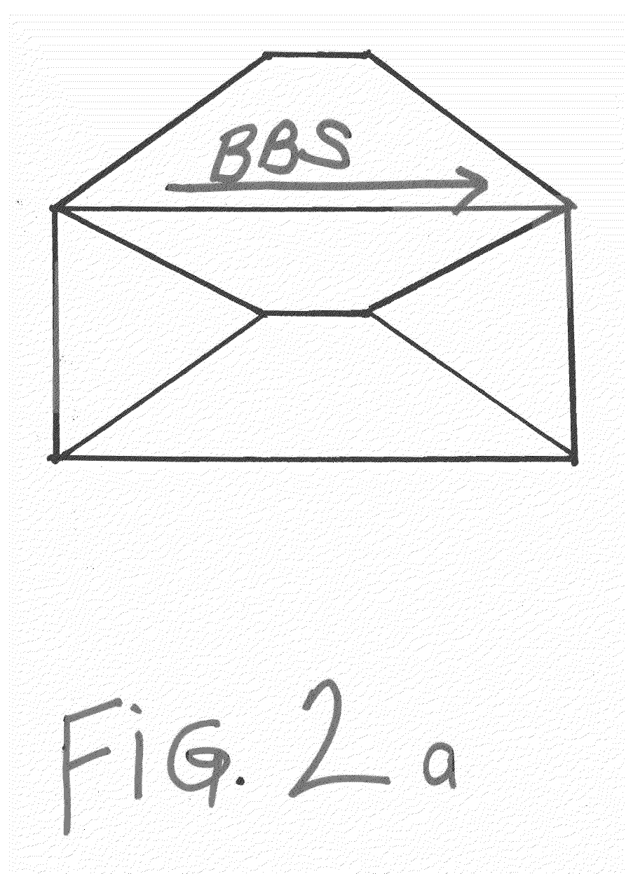

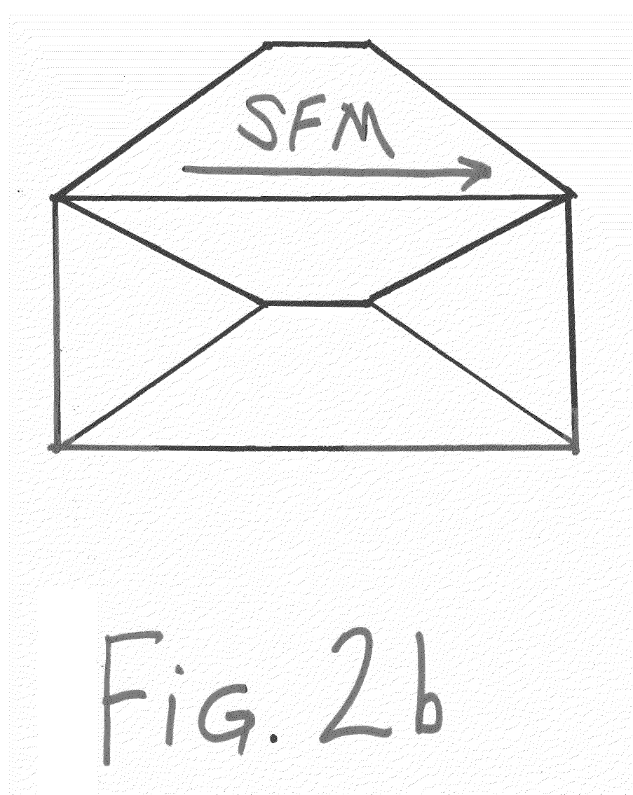

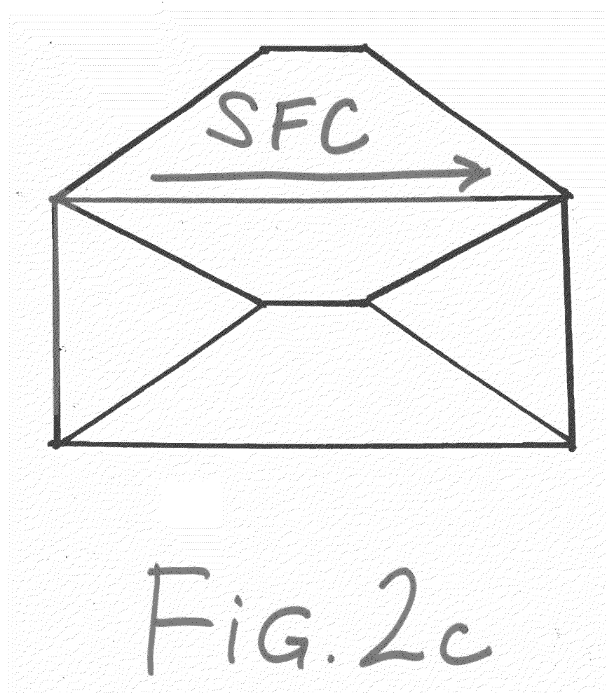

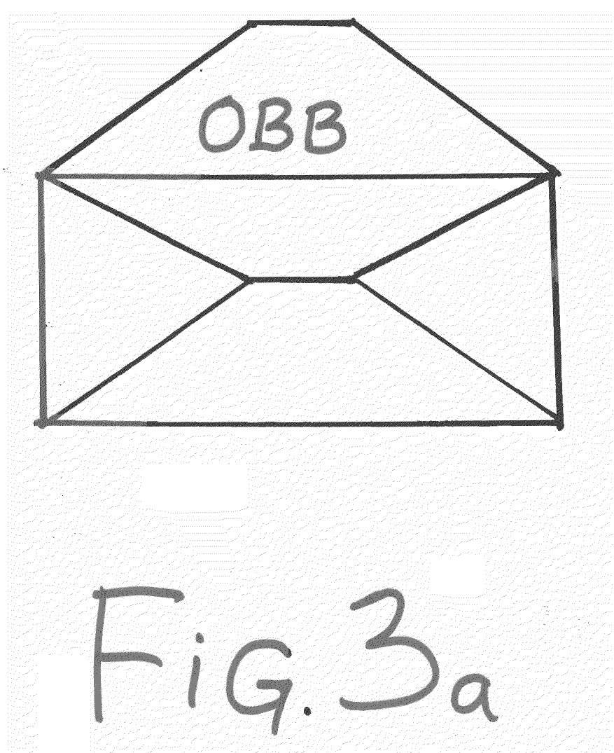

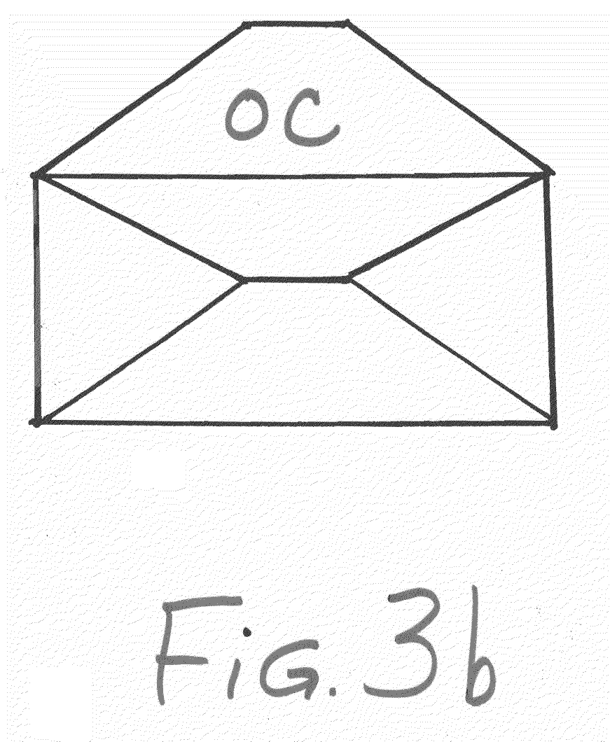

FIG. 1a is an illustration of an opened envelope with a notification showing that a reply was sent from the computer. FIG. 1b is another illustration showing that a reply was sent from a computer. FIG. 1c shows that a reply was sent from the mobile or Blackberry. FIG. 2 is an illustration of an opened envelope showing a notification that a reply was sent from the mobile device (bbs—Blackberry sent). FIG. 2b is another illustration showing a different type of notification (sent from mobile—sfm). FIG. 2c is another illustration showing that a mail message was sent from the computer. FIG. 3 is an illustration of an opened envelope on either the computer or the mobile showing where the mail was opened. FIG. 3a shows that the mail was opened from the mobile device (obb—opened at Blackberry) and FIG. 3b shows that the mail was opened at the computer (oc—opened at computer).

The current invention provides for a variety of solutions to the above mentioned problems. The first problem deals with messages being sent from the computer. Typically when the user sends a message from the computer the message notification does not show up on the mobile. This creates a number of problems because the user does not have total access to all messages via the mobile device.

The present invention provides a first solution to this problem. As shown in FIG. 1, in the first embodiment a notification shows up on the mobile as an opened, sent message. Additionally, the icon shows a notification establishing from where the message was sent. This icon could be such as an opened envelope with a notification such as “sfc” (sent from computer) “cs” (computer sent) or some other notification or message indicating that the mail message was sent from the computer. This would be available on both the mobile and on the computer. The notifications could be different colors also to indicate whether the mail has been opened or not. Additionally, this message could be sent to the mobile and stored in an option “sent” folder on the mobile.

A second problem that is similar to this first problem is that when mail is sent from the mobile the same type of notification appears. That is, when the user sends a message from the mobile it appears on the mobile simply as a mail item with a check mark next to it. This check mark could be an icon that shows where the mail was sent from, such as “bbs” (blackberry sent) or “ms” (mobile sent) or some other similar notification to allow the user to know from where the mail was sent, as is shown in FIG. 2. Again, this notification would be available on both the mobile and the computer and the notifications could be different colors also to indicate whether the mail has been opened or not.

Another solution is to provide a mobile with a separate sent items box such that the user would have to open the “sent” box, just like on a computer, to access the sent items. Thus, the mobile would be extremely similar to the computer message system with an “in” box and a “sent” box.

The next issue is that when the user replies, sends, opens or reads a mail message on the phone there is no way of knowing, after it is opened, sent or read, that it was opened, read or sent from the mobile device. The present invention provides for a method to display a notification, both on the mobile and on the computer, where each message was accessed. For example, if the user is on the mobile and opens a message then the message, both on the mobile and on the computer, will show an envelope icon that has some sort of indicator on it to acknowledge that it was opened from the mobile. If the mobile is a Blackberry then it could be something like FIG. 3 that shows that the message was opened from the mobile device using a notification such as “OBB” for opened from Blackberry. Currently the computer shows that the message was opened but it does not let the user know where it was opened. The present system thus shows “OBB” on both the mobile and on the computer. The notifications could be different colors also to indicate whether the mail has been opened or not, or sent or not.

In FIG. 4 it is shown a response that was sent from a mobile. Thus, if a message is opened and replied to from the mobile device then the user knows because the icon on both the mobile and the computer shows that the message was opened and replied to via the mobile device. And, as noted above, if the mail was responded to from the computer it would likewise show on the mobile as opened and responded to via computer with some suitable representative icon to show the user that the message was responded to from the computer. The notification icons could be different colors also to indicate whether the mail has been opened or not.

The final problem deals with mail maintenance. Currently, a mobile user has the options of opening mail and also deleting mail. The options are usually (a) delete (b) delete on mobile and (c) delete on mobile and computer. This is fine, however there are no options similar to this on the computer. When mail is deleted from the computer it still remains on the mobile device. This is extremely annoying because the user is faced with the same mail on the computer and the mobile and sometimes can mistakenly reread the same mail, even though it was already deleted from the computer.

The present invention provides for a system that deletes messages from the mobile device when the messages are deleted from the computer. In this way the mail is uniform and thus the user does not have to look at unopened mail on the mobile when it has already been deleted from the computer. Thus, when mail is deleted from the computer it is automatically deleted from the mobile device.

As many apparently widely different embodiments of the present invention can be made without departing from the spirit and scope thereof, it is to be understood that the invention is not limited to the specific embodiments thereof except as defined in the appended claims.

What is claimed is:

1. A computer and mobile phone user interface system comprising:
a computer,
a mobile phone,
a messaging system that displays messages on both said computer and said mobile phone that notify said user as to from where the messages were opened or sent.

2. The user interface system of claim 1 that deletes messages from said mobile phone when messages are deleted from said computer.

3. The user interface system of claim 2 that deletes messages from said computer when messages are deleted from said mobile phone.

4. The user interface system of claim 3 that further includes a sent box on said mobile phone such that sent items can be separately stored in said sent box.

5. The user interface system of claim 4 where the notification system uses icons.

6. The user interface system of claim 5 where the notification system icons are different colors to represent message status.

7. A computer and mobile phone user software for enabling the user interaction between said phone and said computer configured to:
display messages on both said phone and on said computer that notify said user as to from where said messages were opened or sent.

8. The software of claim 7 that deletes messages from mobile phone when messages are deleted from said computer.

9. The software of claim 8 that deletes messages from said computer when messages are deleted from said mobile phone.

10. The software of claim 9 that further includes a sent box on said mobile phone such that sent items can be separately stored in said sent box.

11. The software of claim 10 where icons are used to represent message status.

12. The software of claim 11 where said icons are different colors to represent message status.

13. A method of improved handling of messages by a message program comprising the step of:
displaying notification icons on both a computer system and a mobile device that tells a user from where said message was opened or sent.

14. The method of claim 13 that further deletes messages from said mobile device when messages are deleted from said computer.

15. The method of claim 14 that further deletes messages from said computer when messages are deleted from said mobile device.

16. The method of claim 15 that further includes a sent box on said mobile phone such that sent items can be separately stored in said sent box.

17. The method of claim 16 where icons are used to represent message status.

18. The method of claim 17 where said icons are different colors to represent message status.
